(19) United States
(12) Patent Application Publication
(10) Pub. No.: US 2014/0081915 A1
(43) Pub. Date: Mar. 20, 2014

(54) METHOD AND APPARATUS FOR MATCHING PUBLICATIONS AND SUBCRIPTIONS BASED IN PART ON CONTEXTUAL CHARACTERISTICS ASSOCIATED WITH THE SUBSCRIPTIONS OR PUBLICATIONS

(71) Applicant: Nokia Corporation, Espoo (FI)

(72) Inventors: Lik Hang Chow, Beijing (CN); Hao Yang, San Jose, CA (US)

(73) Assignee: Nokia Corporation, Espoo (FI)

(21) Appl. No.: 14/116,174

(22) PCT Filed: May 20, 2011
(86) PCT No.: PCT/CN2011/074421

§ 371 Date: Nov. 7, 2013

(30) Foreign Application Priority Data
May 11, 2011 (DE) 10 2011 641.8

(51) Int. Cl. G06F 17/30

(52) U.S. Cl. CPC G06F 17/30174
USPC 707/627

(57) ABSTRACT

An apparatus may include a registrar configured to register one or more subscription parameters for each of a plurality of subscriptions and one or more publication parameters for each of a plurality of publications. Further, the apparatus may include a matcher configured to match the publications to the subscriptions based on the subscription parameters and the publication parameters. Additionally, the apparatus may include a parameter updater configured to update the subscription parameters or the publication parameters based on one or more contextual characteristics associated with the subscriptions or the publications. Also, a potential match determiner may form a potential match list including one or more pairs of the subscriptions and the publications based on the subscription parameters and the publication parameters. Accordingly, the potential match list may reduce the computational resources needed to match the publications to the subscriptions by only determining matches for those pairs of subscriptions and publications in the potential match list.

### TECHNOLOGICAL FIELD

An example embodiment of the present invention relates generally to techniques for matching publications to subscriptions and, more particularly, relates to an apparatus, a method and a computer program product for matching publications to subscriptions based in part on contextual characteristics associated with the subscriptions or publications.

### BACKGROUND

In order to provide easier or faster information transfer and convenience, telecommunication industry service providers are continually developing improvements to existing communication networks. As a result, wireless communication has become increasingly more reliable in recent years. Along with the expansion and improvement of wireless communication networks, mobile terminals used for wireless communication have also been continually improving. In this regard, due at least in part to reductions in size and cost, along with improvements in battery life and computing capacity, mobile terminals have become more capable, easier to use, and cheaper to obtain. Due to the now ubiquitous nature of mobile terminals, people of all ages and education levels may utilize mobile terminals to communicate with other individuals or contacts, receive services and/or share information, media and other content.

Some of the technologies which are becoming more popular include those which employ publish/subscribe matching systems. These systems may be used, for example to disseminate stock price information from publishers to subscribers interested in specific stock price information. For example, a user may subscribe to receive stock price information relating to stocks which the user owns or which the user is otherwise interested in. Thereby, for example, each time a publisher releases updated stock price information, the matching system may be employed to match the stock price information with subscriptions by users who have registered to receive stock information for that particular stock. Accordingly, the publish/subscribe matching system may direct the stock price information to the users who have subscribed to receive the stock information. Thus, publish/subscribe systems may be employed to disseminate information to interested users. However, it may still be possible to improve the provision of content to users.

### BRIEF SUMMARY

A method, apparatus and computer program product are therefore provided that may recommend content based on content provision models associated with spatial regions.

In an example embodiment, an apparatus comprises at least one processor and at least one memory including computer program code, the at least one memory and the computer program code configured to, with the processor, cause the apparatus to cause registering of one or more subscription parameters for each of a plurality of subscriptions and one or more publication parameters for each of a plurality of publications. Further, the apparatus may cause updating of the subscription parameters or the publication parameters based on one or more contextual characteristics associated with the subscriptions or the publications. Additionally, the apparatus may match the publications to the subscriptions based on the subscription parameters and the publication parameters.

In an additional example embodiment a method comprises causing registering of one or more subscription parameters for each of a plurality of subscriptions and one or more publication parameters for each of a plurality of publications. The method may also include causing updating of the subscription parameters or the publication parameters based on one or more contextual characteristics associated with the subscriptions or the publications. Further, the method may include matching the publications to the subscriptions based on the subscription parameters and the publication parameters.

In a further example embodiment a computer program product comprises at least one computer-readable storage medium having computer-executable program code portions stored therein, the computer-executable program code portions comprising program code instructions causing registering of one or more subscription parameters for each of a plurality of subscriptions and one or more publication parameters for each of a plurality of publications. The computer program product may also include program code instructions causing updating of the subscription parameters or the publication parameters based on one or more contextual characteristics associated with the subscriptions or the publications. Further, the computer program product may include program code instructions for matching the publications to the subscriptions based on the subscription parameters and the publication parameters.

In a further example embodiment an apparatus comprises means for causing registering of one or more subscription parameters for each of a plurality of subscriptions and one or more publication parameters for each of a plurality of publications. The apparatus may also include means for causing updating of the subscription parameters or the publication parameters based on one or more contextual characteristics associated with the subscriptions or the publications. Further, the apparatus may include means for matching the publications to the subscriptions based on the subscription parameters and the publication parameters.

In some embodiments a potential match list comprising one or more pairs of the subscriptions and the publications may be formed based on the subscription parameters and the publication parameters. One of the subscriptions and one of the publications may be omitted as one of the pairs of the potential match list in an instance in which the one of the publications does not include all of a plurality of categories of the subscription parameters of the one of the subscriptions. Further, one of the subscriptions and one of the publications may be omitted as one of the pairs of the potential match list in an instance in which the subscription parameters of the one of the subscriptions include one or more static parameters that do not match the publication parameters of the one of the publications.

Additionally, a range may be assigned to one of the subscription parameters or one of the publication parameters. Further, one of the subscriptions and one of the publications may be omitted as one of the pairs of the potential match list in an instance in which the range does not overlap with a corresponding one of the subscription parameters or the publication parameters. In some embodiments the range may comprise an expected location range associated with the one of the subscriptions or the one of the publications. Also, a new range may be determined for one of the subscription parameters or one of the publication parameters based on a new contextual characteristic associated with the one of the subscriptions or the one of the publications in an instance in which the new contextual characteristic is outside of the range.

User interface circuitry may also be provided which is configured to facilitate user control of at least some functions through use of a display. The user interface circuitry may cause at least a portion of a user interface to be displayed on the display to facilitate user control of at least some functions. Accordingly, embodiments of the present invention may provide improved matching of publications and subscriptions by taking into account contextual characteristics associated with the subscriptions and/or the publications, while reducing the calculation burden through employing a potential match list or other techniques described herein.

### BRIEF DESCRIPTION OF THE SEVERAL VIEWS OF THE DRAWING(S)

Having thus described embodiments of the present disclosure in general terms, reference will now be made to the accompanying drawings, which are not necessarily drawn to scale, and wherein:

FIG. 1 illustrates a schematic block diagram of a system according to an example embodiment of the present invention;

FIG. 2 illustrates a schematic block diagram of an apparatus configured to match publications to subscriptions according to an example embodiment of the present invention;

FIG. 3 illustrates a schematic block diagram of an embodiment of the apparatus of FIG. 2 including additional components configured to match publications to subscriptions according to an example embodiment of the present invention; and

FIG. 4 illustrates a flowchart of the operations performed in matching publications to subscriptions according to an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as may be used herein, is not provided to convey any qualitative assessment, but instead merely to convey an illustration of an example. Thus, use of any such terms should not be taken to limit the spirit and scope of embodiments of the present invention.

As used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a computer-readable storage medium, which refers to a non-transitory, physical storage medium (e.g., volatile or non-volatile memory device), can be differentiated from a computer-readable transmission medium, which refers to an electromagnetic signal.

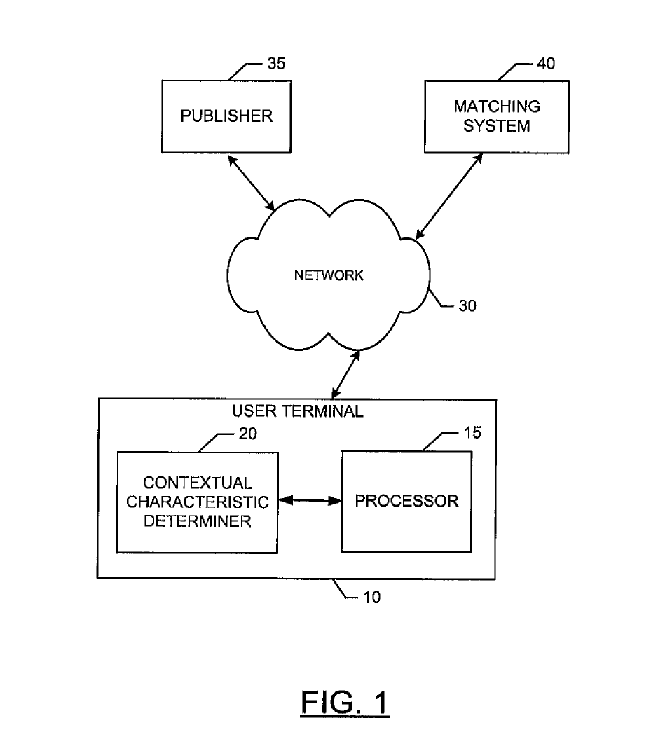

As indicated above, some embodiments of the present invention may be employed in methods, apparatuses and computer program products configured to match publications and subscriptions based at least in part on the contextual characteristics associated with the subscriptions. For example, FIG. 1 illustrates a block diagram of a system that may benefit from embodiments of the present invention. It should be understood, however, that the system as illustrated and hereinafter described is merely illustrative of one system that may benefit from an example embodiment of the present invention and, therefore, should not be taken to limit the scope of embodiments of the present invention.

As shown in FIG. 1, a system in accordance with an example embodiment of the present invention may include a user terminal 10. The user terminal 10 may be any of multiple types of fixed or mobile communication and/or computing devices such as for example, personal digital assistants (PDAs), pagers, mobile televisions, mobile telephones, gaming devices, laptop computers, personal computers (PCs), cameras, camera phones, video recorders, audio/video players, radios, global positioning system (GPS) devices, or any combination of the aforementioned, which employ an embodiment of the present invention.

In some embodiments the user terminal 10 may be capable of communicating with other devices, either directly, or via a network 30. The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like. Thus, the network 30 may be a cellular network, a mobile network and/or a data network, such as a local area network (LAN), a metropolitan area network (MAN), and/or a wide area network (WAN), for example, the Internet. In turn, other devices such as processing elements (for example, personal computers, server computers or the like) may be included in or coupled to the network 30. By directly or indirectly connecting the user terminal 10 and the other devices to the network 30, the user terminal and/or the other devices may be enabled to communicate with each other, for example, according to numerous communication protocols including Hypertext Transfer Protocol (HTTP) and/or the like, to thereby carry out various communication or other functions of the user terminal and the other devices, respectively. As such, the user terminal 10 and the other devices may be enabled to communicate with the network 30 and/or each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as wireless LAN (WLAN), Worldwide Interoperability for Microwave Access (WiMAX), WiFi, ultra-wide band (UWB), Wibree techniques and/or the like and fixed access mechanisms such as digital subscriber line (DSL), cable modems, Ethernet and/or the like. Thus, for example, the network 30 may be a home network or other network providing local connectivity.

The user terminal 10 may be configured to subscribe to one or more publications and receive content provided therefrom. By way of example, content may include Uniform Resource Locators (URLs), text, pictures, data, audio, video, and/or various other embodiments and media formats of content. The user terminal 10 may subscribe to publications by selecting one or more subscription parameters. The subscription parameters may be a collection of predicates defining the type of publications the user is interested in receiving. Each predicate may include information such as a key, value, and an operator, as will be described below.

In some embodiments the user terminal 10 may include a processor 15. The processor 15 may be embodied in a number of different ways. For example, the processor 15 may be embodied as one or more of various processing means such as a coprocessor, a microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a hardware accelerator, a special-purpose computer chip, or other hardware processor. In an example embodiment, the processor 15 may be configured to execute instructions stored in a memory device or otherwise accessible to the processor. Alternatively or additionally, the processor 15 may be configured to execute hard coded functionality. As such, whether configured by hardware or software methods, or by a combination thereof, the processor 15 may represent an entity (for example, physically embodied in circuitry) capable of performing operations according to embodiments of the present invention while configured accordingly. Thus, for example, when the processor 15 is embodied as an ASIC, FPGA or the like, the processor 15 may be specifically configured hardware for conducting the operations described herein. Alternatively, as another example, when the processor 15 is embodied as an executor of software instructions, the instructions may specifically configure the processor to perform the algorithms and/or operations described herein when the instructions are executed. However, in some cases, the processor 15 may be a processor of a specific device (for example, a user terminal or network device such as a server) adapted for employing embodiments of the present invention by further configuration of the processor by instructions for performing the algorithms and/or operations described herein. The processor 15 may include, among other things, a clock, an arithmetic logic unit (ALU) and logic gates configured to support operation of the processor.

Further, in some embodiments the user terminal 10 may comprise a contextual characteristic determiner 20. The processor 15 may be embodied as, include or otherwise control the contextual characteristic determiner 20. The contextual characteristic determiner 20 may be configured to determine one or more contextual characteristics. Contextual characteristics, as used herein, refer to the context of the user of the user terminal 10 and/or the user terminal itself, and thus contextual characteristics may include the present time, location, activity, etcetera of the user and/or the user terminal 10. In this regard, the contextual characteristics may be associated with subscriptions by the user. Accordingly, for example, the contextual characteristic determiner 20 may determine that the user is presently at home or outside and moving. Information relating to the location and speed of the user may, for example, be provided by a GPS module, though location and speed information may additionally or alternatively be provided through other means such as triangulation using cell phone towers in some embodiments. Thus, the user terminal 10 may determine one or more contextual characteristics.

As noted above, the user terminal 10 may be configured to subscribe to one or more publications. Publications, as used herein, refer to any content or information which is distributed. Conversely, subscribers refer to users (and/or the user terminals 10 or other devices associated therewith) which issue subscriptions requesting receipt of publications. Thus, one or more publishers 35 may be configured to provide for output of the publications for receipt by the subscribers. One or more of the publishers 35 may be embodied as a server, server bank or other computer or other computing device or node configured to provide for output of publications. Each publication outputted by the publishers 35 may include publication parameters describing the content of the publications. For example, the publications may have attributes in the form of keys and values, as described below.

The system may further include a matching system 40. The matching system 40 may be embodied as a server, server bank or other computer or other computing device or node configured to match the publications by the publishers 35 to subscriptions (e.g., issued by the user of the user terminal 10) so that users may be provided with publications that they are interested in. In this regard, the matching system 40 may be configured to match the publications to the subscriptions based on the subscription parameters and the publication parameters.

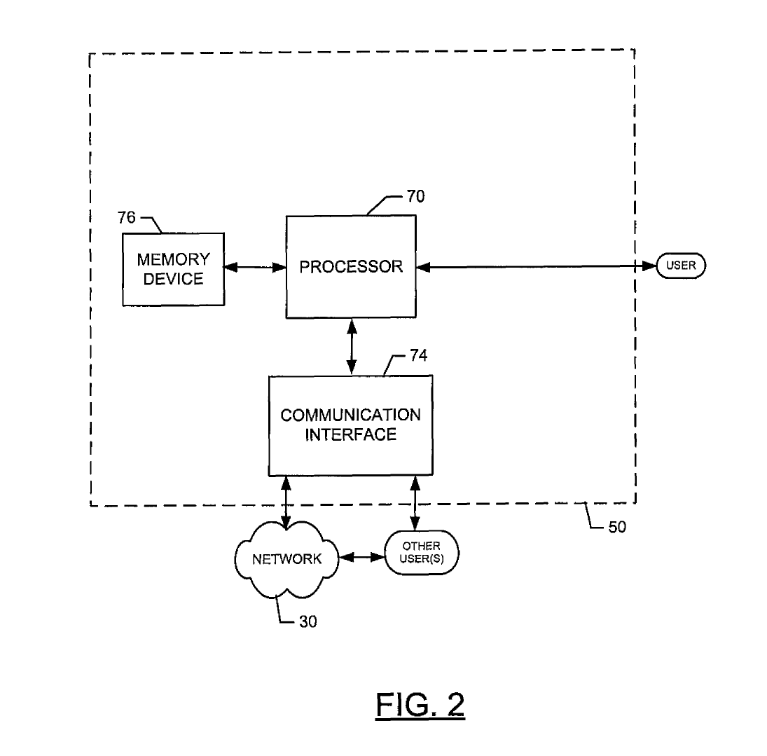

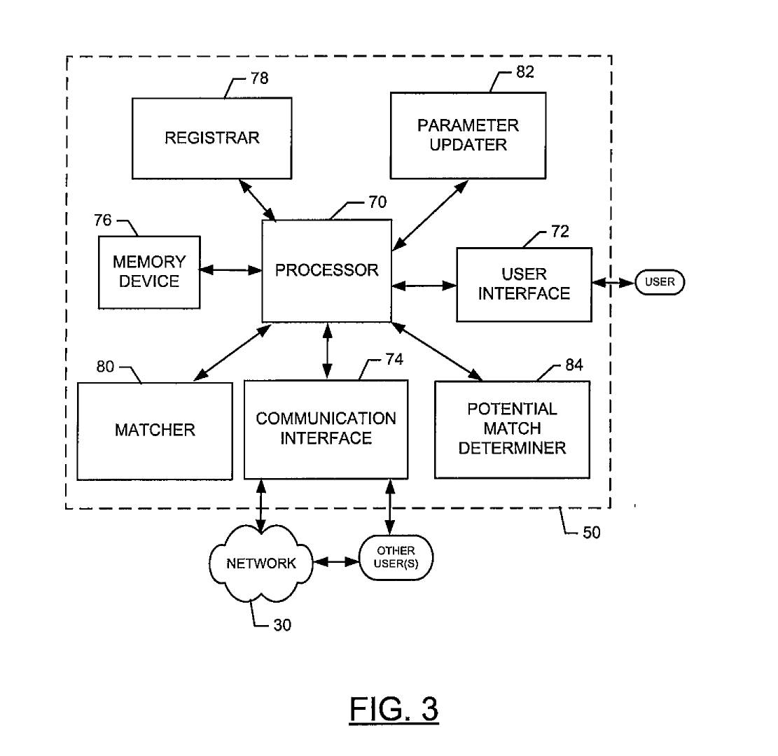

In example embodiments illustrated in FIGS. 2 and 3, an apparatus 50 is provided that may be employed by devices performing example embodiments of the present invention. The apparatus 50 may be embodied, for example, as any device hosting, including, controlling, comprising, or otherwise forming a portion of the user terminal 10, the publishers 35, and/or the matching system 40. However, embodiments may also be embodied on a plurality of other devices such as for example where instances of the apparatus 50 may be embodied on the network 30. As such, embodiments of the apparatus 50 illustrated in FIGS. 2 and 3 are merely examples and may include more, or in some cases, less than the components shown in FIGS. 2 and 3.

With further regard to FIGS. 2 and 3, the apparatus 50 may be configured to match publications to the subscriptions based at least in part on subscription parameters and publication parameters and contextual characteristics associated with subscriptions. As depicted in FIG. 2, the apparatus 50 may include or otherwise be in communication with a processor 70, a communication interface 74, and a memory device 76. The memory device 76 may include non-transitory and tangible memory that may be, for example, volatile and/or non-volatile memory. The memory device 76 may be configured to store information, data, files, applications, instructions or the like. For example, the memory device 76 could be configured to buffer input data for processing by the processor 70. Additionally or alternatively, the memory device 76 could be configured to store instructions for execution by the processor 70.

As mentioned above, the apparatus 50 may, in some embodiments, be a user terminal or a fixed communication device or computing device such as a server configured to employ an example embodiment of the present invention. However, in some embodiments, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 70 may be embodied in a number of different ways. For example, the processor 70 may be embodied as one or more of various processing means such as a coprocessor, a microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a hardware accelerator, a special-purpose computer chip, or other hardware processor. In an example embodiment, the processor 70 may be configured to execute instructions stored in the memory device 76 or otherwise accessible to the processor. Alternatively or additionally, the processor 70 may be configured to execute hard coded functionality. As such, whether configured by hardware or software methods, or by a combination thereof, the processor 70 may represent an entity (for example, physically embodied in circuitry) capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor to perform the algorithms and/or operations described herein when the instructions are executed. However, in some cases, the processor 70 may be a processor of a specific device (for example, a user terminal or network device such as a server) adapted for employing embodiments of the present invention by further configuration of the processor by instructions for performing the algorithms and/or operations described herein. The processor 70 may include, among other things, a clock, an arithmetic logic unit (ALU) and logic gates configured to support operation of the processor.

The communication interface 74 may be any means such as a device or circuitry embodied in either hardware, software, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (for example, network 30). In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet, High-Definition Multimedia Interface (HDMI) or other mechanisms. Furthermore, the communication interface 74 may include hardware and/or software for supporting communication mechanisms such as BLUETOOTH®, Infrared, UWB, WiFi, and/or the like, which are being increasingly employed in connection with providing home connectivity solutions.

As mentioned above, embodiments of the apparatus 50 may include more, or in some cases less, than the components shown in FIG. 2. In this regard, FIG. 3 illustrates an embodiment of the apparatus 50 comprising additional components configured to match publications to subscriptions based at least in part on subscription parameters, publication parameters, and contextual characteristics associated with subscriptions. The apparatus 50 may include or otherwise be in communication with the processor 70, the communication interface 74, and the memory device 76 as described above with respect to FIG. 2. Note that a module, as may be used herein, need not necessarily be modularized, but instead may be distributed in some embodiments. Thus, the term module is only used to designate the functions associated with or performed by the respective module, rather than any structure associated therewith.

In some embodiments the apparatus 50 may further comprise a user interface 72. The user interface 72 may be in communication with the processor 70 to receive an indication of a user input at the user interface and/or to provide an audible, visual, mechanical or other output to the user. As such, the user interface 72 may include, for example, a keyboard, a mouse, a joystick, a display, a touch screen, a microphone, a speaker, or other input/output mechanisms.

The processor 70 may comprise user interface circuitry configured to control at least some functions of one or more elements of the user interface 72, such as, for example, the speaker, the ringer, the microphone, the display, and/or the like. The processor 70 and/or user interface circuitry comprising the processor 70 may be configured to control one or more functions of one or more elements of the user interface 72 through computer program instructions (for example, software and/or firmware) stored on a memory accessible to the processor 70 (for example, memory device 76, and/or the like).

In some embodiments the apparatus 50 may comprise a registrar 78 that may be configured to cause registering of one or more subscription parameters for each of a plurality of subscriptions and one or more publication parameters for each of a plurality of publications. The processor 70 may be embodied as, include or otherwise control the registrar 78. The registrar 78 may receive the subscription parameters from each of a plurality of devices (e.g., the user terminal 10) for which the users associated therewith want to receive publications. Further, the registrar 78 may receive the publication parameters from one or more publishers 35. Accordingly, the registrar 78 may record the subscription and publication parameters.

As noted above, the matching system 40 may match subscriptions by users with publications that they may have an interest in. In this regard, the apparatus 50 may further comprise a matcher 80. The processor 70 may be embodied as, include or otherwise control the matcher 80. The matcher 80 may be configured to match the publications to the subscriptions based on the subscription parameters and the publication parameters. As noted above, the subscription parameters may be a collection of predicates defining the type of publications the user is interested in receiving. Each predicate may include information such as a key, value, and an operator. Further, each publication outputted by the publishers 35 may include publication parameters describing the content of the publications. For example, the publications may have attributes in the form of keys and values.

Accordingly, by way of example, the matcher 80 may match the subscription parameters to the publication parameters. For example, if a user is interested in receiving publications regarding discounts of twenty percent or greater for fashion clothing in Charlotte, North Carolina, the subscription parameters sent to the matching system 40 may appear as follows:

(Location, Charlotte North Carolina, within)

(Shop Category, Fashion, within)

(Discount, 0.2, ≧)

In this example embodiment, the subscription parameters are listed in the following format: (Key, Value, Operator). However, various other formats and embodiments of subscription parameters may be employed in other embodiments.

By way of further example, a store named Nokwear may publish a publication indicating that they it is a fashion store that is presently selling clothing at its location (within Charlotte, N.C.) at a thirty percent discount. In one embodiment, the publication parameters sent to the matcher 80 may appear as follows:

(Location, Nokwear Location)

(Shop Category, Fashion)

(Discount, 0.3)

In this example embodiment, the publication parameters are listed in the following format: (Key, Value). However, various other formats and embodiments of publication parameters may be employed in other embodiments.

As noted above, the matcher 80 may compare the publication parameters of the publications with the subscription parameters of the subscriptions. Accordingly, under the example, provided above, the matcher 80 may determine that the location (Charlotte, N.C.), category (Fashion) and discount (thirty percent) all fall within the specified subscription parameters. Accordingly, the publication from Nokwear may be directed to the user, which may be interested in receiving the publication.

However, the apparatus 50 may include additional features configured to enhance the matching of publications to subscriptions. In this regard, the apparatus 50 may further comprise a parameter updater 82. The processor 70 may be embodied as, include or otherwise control the parameter updater 82. The parameter updater 82 may be configured to cause updating of the subscription parameters for the subscriptions based on one or more contextual characteristics associated with the subscriptions. As noted above, contextual characteristics, as used herein, may refer to the context of the user who issues a subscription and/or the user terminal 10 itself, and thus contextual characteristics may include the present time, location, activity, etcetera of the user and/or the user terminal. Accordingly, rather than only matching the publications to the subscriptions at the time of the publication of the publications, the matcher 80 may additionally match the publications to the subscriptions as the subscription parameters update.

In this regard, by way of example, the parameter updater 82 may be configured to update location information of the user. For example, as described above, the contextual characteristic determiner 20 of the user terminal 10 may be configured to determine the location of the user. Thereby, the user terminal 10 (or other device) may send updated location information (and/or other contextual characteristics associated with the user) to the matching system 40 (as may be embodied by or as the apparatus 50). Accordingly, the parameter updater 82 may update the subscription parameters as may be appropriate. For example, if a user is interested in receiving publications regarding discounts of twenty percent or greater for fashion clothing within five hundred meters of his or her present location, the subscription parameters sent to the matching system 40 may appear as follows:

(Location, Current Location, ≦500 meters)

(Shop Category, Fashion, within)

(Discount, 0.2, ≧)

By using subscription parameters employing location information (or other contextual characteristics), the parameter updater 82 may update the subscription parameters for the subscriptions as they change. Accordingly, under the above-provided example, when Nokwear sends a publication in the same example format provided above, and the matcher 80 determines that the user's location is within five hundred meters of Nokwear's location, the matcher may match the publication to the subscription by the user such that the user receives the publication. Accordingly, the publications may be more closely associated with the present context of the user, such as the location thereof as described in the above-provided example.

However, updating the matches of subscriptions and publications based on each of the subscription parameters and each of the publication parameters every time the apparatus 50 is provided with new contextual characteristics associated with the subscriptions may require significant computational capacity when the number of subscriptions, publications, and updates of contextual characteristics increases. Accordingly, the apparatus 50 may include features configured to reduce the computational burden associated with matching the publications and subscriptions.

In this regard, the apparatus 50 may further comprise a potential match determiner 84. The processor 70 may be embodied as, include or otherwise control the potential match determiner 84. The potential match determiner 84 may be configured to form a potential match list comprising one or more pairs of the subscriptions and the publications based on the subscription parameters and the publication parameters. The potential match list may be provided in any form, such as table(s), database(s), vector(s), list(s), etcetera. The potential match list may comprise a group of the subscriptions and the publications for which the potential match determiner 84 determines that a match may be likely in the future. In this regard, the potential match determiner 84 may include pairs of subscriptions and publications for which matching is determined to be likely and omit pairs of subscriptions and publications for which matching is determined to be unlikely from the potential match list. Accordingly, the matcher 80 may determine if matches exist for the publications and the subscriptions which appear in the potential match list when subscription parameters are updated based on contextual characteristics associated with the subscriptions, rather than determining matches from all of the subscriptions and publications, which may require more calculations.

Thus, the potential match determiner 84 may omit pairs of subscriptions and publications for which a match is unlikely, as mentioned above. In this regard, in some embodiments the potential match determiner 84 may be configured to omit one of the subscriptions and one of the publications as one of the pairs of the potential match lists in an instance in which the one of the publications does not include all of a plurality of categories of the subscription parameters of the one of the subscriptions. For example, in the examples described above, the subscription parameters of the subscription specify requirements for a discount and a location. Accordingly, each of the publications that do not include publication parameters specifying discount and location categories may be omitted from the potential match list.

Further, in some embodiments the potential match determiner 84 may be configured to omit one of the subscriptions and one of the publications as one of the pairs of the potential match list in an instance in which the subscription parameters of the one of the subscriptions include one or more static parameters that do not match the publication parameters of the one of the publications. For example, in the examples described above, the subscription parameters of the subscription specify a fashion category. Accordingly, each of the publications that do not specify through their publication parameters that they relate to a fashion category may be omitted from the potential match list by the potential match determiner 84. For example, a publication that includes a hardware or automotive category, instead of fashion, may be omitted. Thus, static parameters may be employed to filter out those pairs of publications and subscriptions for which matches are unlikely.

Additionally, the potential match determiner 84 may be configured to assign a range to one of the subscription parameters and/or one of the publication parameters and omit one of the subscriptions and one of the publications as one of the pairs of the potential match list in an instance in which the range does not overlap with a corresponding one of the subscription parameters or the publication parameters. By way of example, the position of a user may be expected to not change greatly relative to a prior position (depending on whether or not a user is traveling and the mode of transportation employed). In this regard, the range may comprise an expected location range associated with a subscription (e.g., the location of the user who issued the subscription) in some embodiments, which may, for example, be defined as a circle defined by a radius. Accordingly, pairs of publications and subscriptions may be omitted from the potential match list when it is determined that the range(s) associated with the subscription and the publication will likely not overlap. For example, a user located in Finland is unlikely to shop in a store in Sri Lanka.

In some embodiments the potential match determiner 84 may be further configured to determine a new range for one of the subscriptions based on a new contextual characteristic associated with the one of the subscriptions in an instance in which the new contextual characteristic is outside of the range. For example, the potential match determiner 84 may determine an expected location range associated with a subscription, as described above. If the next contextual characteristics associated with the subscription indicate that the user is within the expected location range, the potential match determiner 84 may not recalculate the expected location range associated with the subscription and the potential match list need not be updated. However, if the next contextual characteristics associated with the subscription indicate that the user is outside the expected location range, the potential match determiner 84 may determine a new range of the user based on the new contextual characteristics associated with the subscription.

Accordingly, the potential match list may reduce the computational burden on the apparatus 50 by reducing the number of match determinations that the matcher 80 conducts. In this regard, in some embodiments the matcher 80 may only determine if matches exist for ₜhose pairs of publications and subscriptions that are included in the potential match list by the potential match determiner 84. Accordingly, the subscription parameters may be updated based on contextual characteristics associated with the subscription without necessarily requiring recalculation of the matches for every received contextual characteristic.

In the preceding description, example embodiments are generally described in terms of users issuing subscriptions. However, the present disclosure also includes embodiments in which users issue publications. In this regard, for example, a user may issue a publication including publication parameters indicating that the user has a coupon for a restaurant he or she wants to sell or give away. If another user issues a subscription including subscription parameters indicating that he or she is looking for a coupon for a restaurant, the publication and the subscription may be matched. Contextual characteristics may also be considered in a similar manner, as described above. For example, either or both of the publication and the subscription may include parameters (e.g., publication parameters and/or subscription parameters) specifying expected location ranges that may be updated based on contextual characteristics associated with the publication and/or the user. By way of further example, expected location ranges of the two users may be updated based on contextual characteristics thereof, such that a match may occur when there is overlap in the ranges based on specified parameters such as the two users coming within one kilometer of each other. Accordingly, subscription parameters and/or publication parameters may be updated based on contextual characteristics according to various embodiments of the present disclosure.

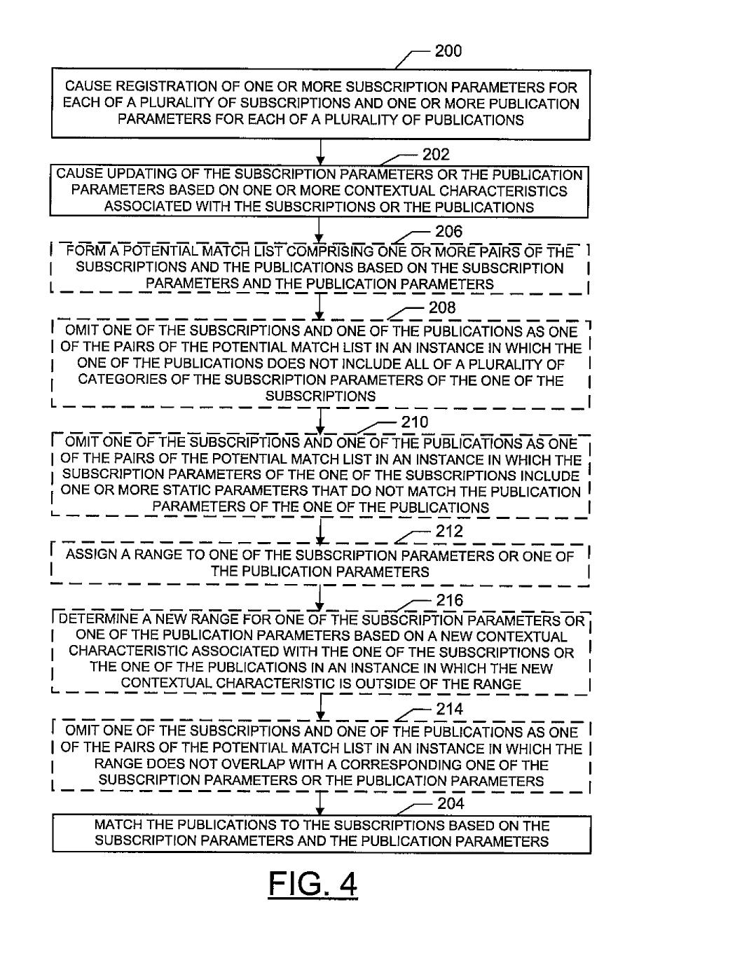

In terms of methods associated with embodiments of the present invention, the above-described apparatus 50 or other embodiments of apparatuses may be employed. In this regard, FIG. 4 is a flowchart of a system, method and program product according to example embodiments of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by a computer program product including computer program instructions. In this regard, the computer program instructions which embody the procedures described above may be stored by a memory device and executed by a processor of an apparatus. As will be appreciated, any such computer program instructions may be loaded onto a computer or other programmable apparatus (for example, hardware) to produce a machine, such that the resulting computer or other programmable apparatus embody means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

In this regard, one embodiment of a method may include causing registering of one or more subscription parameters for each of a plurality of subscriptions and one or more publication parameters for each of a plurality of publications at operation 200. Further, the method may include causing updating of the subscription parameters or the publication parameters based on one or more contextual characteristics associated with the subscriptions or the publications at operation 202. Additionally, the method may include matching the publications to the subscriptions based on the subscription parameters and the publication parameters at operation 204.

In some embodiments, certain ones of the above-described operations (as illustrated in solid lines in FIG. 4) may be modified or further amplified. In some embodiments additional operations may also be included (some examples of which are shown in dashed lines in FIG. 4). It should be appreciated that each of the modifications, optional additions or amplifications may be included with the above-described operations (200-204) either alone or in combination with any others among the features described herein. As such, each of the other operations as will be described herein may be combinable with the above-described operations (200-204) either alone or with one, more than one, or all of the additional operations in any combination.

For example, the method may further include forming a potential match list comprising one or more pairs of the subscriptions and the publications based on the subscription parameters and the publication parameters at operation 206. Forming the potential match list at operation 206 may comprise omitting one of the subscriptions and one of the publications as one of the pairs of the potential match list in an instance in which the one of the publications does not include all of a plurality of categories of the subscription parameters of the one of the subscriptions at operation 208. Further, forming the potential match list at operation 206 may comprise omitting one of the subscriptions and one of the publications as one of the pairs of the potential match list in an instance in which the subscription parameters of the one of the subscriptions include one or more static parameters that do not match the publication parameters of the one of the publications at operation 210.

Forming the potential match list at operation 206 may additionally include assigning a range to one of the subscription parameters or one of the publication parameters at operation 212 and omitting one of the subscriptions and one of the publications as one of the pairs of the potential match list in an instance in which the range does not overlap with a corresponding one of the subscription parameters or the publication parameters at operation 214. In some embodiments the range may comprise an expected location range associated with the one of the subscriptions or the one of the publications. Further, the method may include determining a new range for one of the subscription parameters or the publication parameters based on a new contextual characteristic associated with the one of the subscriptions or the one of the publications in an instance in which the new contextual characteristic is outside of the range at operation 216. Accordingly, the potential match formed during one or more of operations 206-214 may simplify matching the publications to the subscriptions at operation 204 by reducing the number of subscriptions and publications for which it is determined if a match is reduced.

In an example embodiment, an apparatus for performing the method of FIG. 4 and other methods described above may comprise a processor (for example, the processor 70) configured to perform some or each of the operations (200-216) described above. The processor may, for example, be configured to perform the operations (200-216) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 200-216 may comprise, for example, the processor 70, the user interface 72, the communication interface 74, the registrar 78, the matcher 80, the parameter updater 82, and the potential match determiner 84, as described above. However, the above-described portions of the apparatus 50 as they relate to the operations of the method illustrated in FIG. 4 are merely examples, and it should be understood that various other embodiments may be possible.

In some embodiments the operation 200 of causing registering of one or more subscription parameters for each of a plurality of subscriptions and one or more publication parameters for each of a plurality of publications may be conducted by means, such as the registrar 80, the communication interface 74, and/or the processor 70. Additionally, the operation 202 of causing updating of the subscription parameters or the publication parameters based on one or more contextual characteristics associated with the subscriptions or the publications may be conducted by means, such as the registrar 78, the parameter updater 82, and/or the processor 70. Also, the operation 204 of matching the publications to the subscriptions based on the subscription parameters and the publication parameters may be conducted by means, such as the registrar 78, the matcher 80, and/or the processor 70.

Further, assigning a range to one of the subscription parameters or one of the publication parameters at operation 206 may be conducted by means, such as the register 80, the parameter updater 82, the potential match determiner 84, and/or the processor 70. Additionally, the operation 208 of omitting one of the subscriptions and one of the publications as one of the pairs of the potential match list in an instance in which the one of the publications does not include all of a plurality of categories of the subscription parameters of the one of the subscriptions may be conducted by means, such as the register 80, the parameter updater 82, the potential match determiner 84, and/or the processor 70. Additionally, the operation 210 of omitting one of the subscriptions and one of the publications as one of the pairs of the potential match list in an instance in which the subscription parameters of the one of the subscriptions include one or more static parameters that do not match the publication parameters of the one of the publications may be conducted by means, such as the register 80, the parameter updater 82, the potential match determiner 84, and/or the processor 70.

Also, the operation 212 of assigning a range to one of the subscription parameters or one of the publication parameters may be conducted by means, such as the register 80, the parameter updater 82, the potential match determiner 84, and/or the processor 70. Further, the operation 214 of omitting one of the subscriptions and one of the publications as one of the pairs of the potential match list in an instance in which the range does not overlap with a corresponding one of the subscription parameters or the publication parameters may be conducted by means, such as the register 80, the parameter updater 82, the potential match determiner 84, and/or the processor 70. Additionally, the operation 216 of determining a new range for one of the subscription parameters or one of the publication parameters based on a new contextual characteristic associated with the one of the subscriptions or the one of the publications in an instance in which the new contextual characteristic is outside of the range may be conducted by means, such as the register 80, the parameter updater 82, the potential match determiner 84, and/or the processor 70.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1-23. (canceled)

24. An apparatus comprising at least one processor and at least one memory including computer program code, the at least one memory and the computer program code configured to, with the processor, cause the apparatus to:
cause registration of one or more subscription parameters for each of a plurality of subscriptions and one or more publication parameters for each of a plurality of publications;
cause updating of the subscription parameters or the publication parameters based on one or more contextual characteristics associated with the subscriptions or the publications; and
match the publications to the subscriptions based on the subscription parameters and the publication parameters.

25. The apparatus of claim 24, further comprising forming a potential match list comprising one or more pairs of the subscriptions and the publications based on the subscription parameters and the publication parameters.

26. The apparatus of claim 25, wherein forming the potential match list comprises omitting one of the subscriptions and one of the publications as one of the pairs of the potential match list in an instance in which the one of the publications does not include all of a plurality of categories of the subscription parameters of the one of the subscriptions.

27. The apparatus of claim 25, wherein forming the potential match list comprises omitting one of the subscriptions and one of the publications as one of the pairs of the potential match list in an instance in which the subscription parameters of the one of the subscriptions include one or more static parameters that do not match the publication parameters of the one of the publications.

28. The apparatus of claim 25, wherein forming the potential match list comprises:
assigning a range to one of the subscription parameters or one of the publication parameters; and
omitting one of the subscriptions and one of the publications as one of the pairs of the potential match list in an instance in which the range does not overlap with a corresponding one of the subscription parameters or the publication parameters.

29. The apparatus of claim 28, wherein the range comprises an expected location range associated with one of the subscriptions or one of the publications.

30. The apparatus of claim 28, further comprising determining a new range for one of the subscription parameters or one of the publication parameters based on a new contextual characteristic associated with the one of the subscriptions or the one of the publications in an instance in which the new contextual characteristic is outside of the range.

31. The apparatus of claim 24, further comprising user interface circuitry configured to:
facilitate user control of at least some functions of the apparatus through use of a display; and
cause at least a portion of a user interface of the apparatus to be displayed on the display to facilitate user control of at least some functions of the apparatus.

32. A method, comprising:
causing registering of one or more subscription parameters for each of a plurality of subscriptions and one or more publication parameters for each of a plurality of publications;
causing updating of the subscription parameters or the publication parameters based on one or more contextual characteristics associated with the subscriptions or the publications; and
matching the publications to the subscriptions based on the subscription parameters and the publication parameters.

33. The method of claim 32, further comprising forming a potential match list comprising one or more pairs of the subscriptions and the publications based on the subscription parameters and the publication parameters.

34. The method of claim 33, wherein forming the potential match list comprises omitting one of the subscriptions and one of the publications as one of the pairs of the potential match list in an instance in which the one of the publications does not include all of a plurality of categories of the subscription parameters of the one of the subscriptions.

35. The method of claim 33, wherein forming the potential match list comprises omitting one of the subscriptions and one of the publications as one of the pairs of the potential match list in an instance in which the subscription parameters of the one of the subscriptions include one or more static parameters that do not match the publication parameters of the one of the publications.

36. The method of claim 33, wherein forming the potential match list comprises:
assigning a range to one of the subscription parameters or one of the publication parameters; and
omitting one of the subscriptions and one of the publications as one of the pairs of the potential match list in an instance in which the range does not overlap with a corresponding one of the subscription parameters or the publication parameters.

37. The method of claim 36, wherein the range comprises an expected location range associated with the one of the subscriptions or one of the publications.

38. The method of claim 36, further comprising determining a new range for one of the subscription parameters or the publication parameters based on a new contextual characteristic associated with the one of the subscriptions or the one of the publications in an instance in which the new contextual characteristic is outside of the range.

39. A computer program product comprising at least one computer-readable storage medium having computer-executable program code portions stored therein, the computer-executable program code portions comprising:
program code instructions causing registering of one or more subscription parameters for each of a plurality of subscriptions and one or more publication parameters for each of a plurality of publications;
program code instructions causing updating of the subscription parameters or the publication parameters based on one or more contextual characteristics associated with the subscriptions or the publications; and
program code instructions for matching the publications to the subscriptions based on the subscription parameters and the publication parameters.

40. The computer program product of claim 39, further comprising program code instructions for forming a potential match list comprising one or more pairs of the subscriptions and the publications based on the subscription parameters and the publication parameters.

41. The computer program product of claim 40, wherein program code instructions for forming the potential match list comprise program code instructions for omitting one of the subscriptions and one of the publications as one of the pairs of the potential match list in an instance in which the one of the publications does not include all of a plurality of categories of the subscription parameters of the one of the subscriptions.

42. The computer program product of claim 40, wherein program code instructions for forming the potential match list comprise program code instructions for omitting one of the subscriptions and one of the publications as one of the pairs of the potential match list in an instance in which the subscription parameters of the one of the subscriptions include one or more static parameters that do not match the publication parameters of the one of the publications.

43. The computer program product of claim 40, wherein program code instructions for forming the potential match list comprise:
program code instructions for assigning a range to one of the subscription parameters or one of the publication parameters; and
program code instructions for omitting one of the subscriptions and one of the publications as one of the pairs of the potential match list in an instance in which the range does not overlap with a corresponding one of the subscription parameters or the publication parameters.
